(19) United States
(12) Patent Application Publication
(10) Pub. No.: US 2017/0301197 A1
(43) Pub. Date: Oct. 19, 2017

(54) Emergency Responder Alert System

(71) Applicant: Rocco Lucciola, Brick, NJ (US)

(72) Inventor: Rocco Lucciola, Brick, NJ (US)

(21) Appl. No.: 15/457,112

(22) Filed: Mar. 13, 2017

Related U.S. Application Data
(60) Provisional application No. 62/322,332, filed on Apr. 14, 2016.

(51) Int. Cl. G08B 7/06; G08B 25/01

(52) U.S. Cl. CPC G08B 7/064; G08B 25/016

(57) ABSTRACT

A kit and a systematic method for alerting emergency responders of an exact location in which they have been dispatched. The system includes a container for holding medication, a strobe light and indicia for signaling the emergency responders as they approach the dispatched location. The container includes a removable seal and a hinged cap for accessing an interior volume thereof. A desiccant is secured to the bottom of the container for absorbing moisture. The kit may be powered via a solar power assembly. Further, the strobe light can be remotely activated via a conspicuous lighted button. In operation, the indicia is positioned on the exterior of a residence that indicates the user's address. As a user feels an onset of a heart attack or other emergency, then takes the medication, dials 9-1-1 immediately, unlocks the door and activates the strobe light.

### CROSS REFERENCE TO RELATED APPLICATION

This application claims the benefit of U.S. Provisional Application No. 62/322,332 filed on Apr. 14, 2016. The above identified patent application is herein incorporated by reference in its entirety to provide continuity of disclosure.

### BACKGROUND OF THE INVENTION

The present invention relates to emergency alert system. More specifically, the present invention provides a system comprising a container for holding medication, a strobe light and reflective indicia for alerting emergency responders of an exact location in which they have been dispatched.

Guidelines have been issued to help people to know what to do in the event that they or someone they know is having a heart attack. These guidelines instruct that the person suffering a heart attack take one chewable 325 mg uncoated aspirin tablets and then immediately call for emergency assistance, such as 911. However, a person who is at risk of having a heart attack may not have immediate access to aspirin at all times. This is particularly true for elderly individuals who may have difficulty moving about to locate aspirin or who may have poor vision that prevents them from identifying a bottle of aspirin. Further, according to several heart associations, the rate of heart attacks nationwide is approximately 790,000, leading to 114,000 fatalities. Thus, a device for allowing users to have immediate and easy access to aspirin in the event of a heart attack is desired.

Calling for emergency assistance is crucial when an individual is having a heart attack. However, some residences are not clearly marked such that an emergency responder knows exactly where to go. If an emergency responder passes the location to which they are dispatched, they have to turn around and locate the address. This waste crucial time in which the individual may not have a moment to spare. Therefore, there further exists a need for a system and method of alerting an emergency responder of an exact location in which they have been dispatched. Specifically, a strobe light and address numbers designed to reflect light from an oncoming vehicle.

### SUMMARY OF THE INVENTION

In view of the foregoing disadvantages inherent in the known types of emergency responder alert systems now present in the prior art, the present invention provides a new emergency responder alert system wherein the same can be utilized for providing convenience for the user when alerting emergency responders of an exact location in which they have been dispatched, which can save lives in the multitude.

It is therefore an object of the present invention to provide a new and improved emergency responder alert system that has all of the advantages of the prior art and none of the disadvantages. The system includes a container for holding medication, wherein the container is attached to a lanyard that is adapted to be worn around a user's neck at all times, a flashing light and indicia which includes reflective address numbers for signaling the emergency responders as they approach the dispatched location. The container includes a removable seal and a cap for accessing an interior volume thereof. A desiccant is secured to the bottom of the container for absorbing moisture. In some embodiments, the system includes a door lock. Further, the light can be remotely activated via a conspicuous lighted button adapted to be positioned on an interior wall adjacent to an exit door. In operation, the reflective indicia is positioned on the exterior of a residence that indicates the user's address. As a user feels an onset of a heart attack the user then takes the medication, dials an emergency responder, unlocks the door and activates the strobe light. The system is adapted to maintain operation in the event of a power outage, and could also be activated for emergencies other than a heart attack

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the emergency responder alert system.

FIG. 2 shows a perspective view of the container of the emergency responder alert system.

FIG. 3 shows a diagram of the control circuit of the emergency responder alert system.

### DETAILED DESCRIPTION OF THE INVENTION

Reference is made herein to the attached drawings. Like reference numerals are used throughout the drawings to depict like or similar elements of the emergency responder alert system. For the purposes of presenting a brief and clear description of the present invention, the preferred embodiment will be discussed as used for alerting emergency responders of an exact location in which they have been dispatched. The figures are intended for representative purposes only and should not be considered to be limiting in any respect.

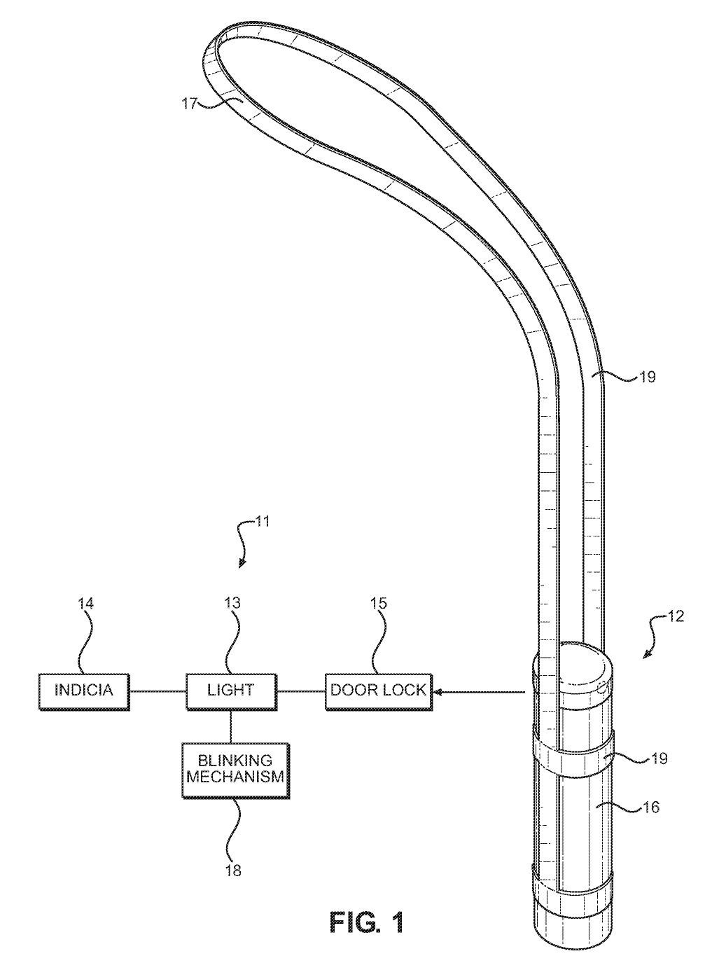

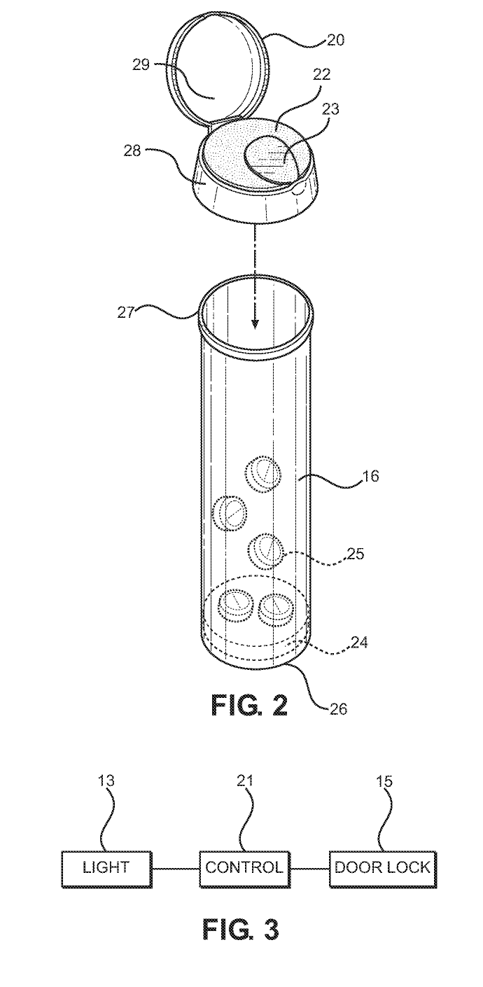

Referring now to FIGS. 1 and 2, there is shown a perspective view of an embodiment of the emergency responder alert system and a perspective view of the container of the emergency responder alert system, respectively. The system 11 includes a container 12 for holding medication, such as a 325 milligram chewable uncoated aspirin 25. The container 12 is adapted to hold multiple 325 milligram chewable uncoated aspirin 25 in the event of accidental spillage, which is very likely to occur in an emergency situation. The container 12 comprises a closed bottom 26, an open end 27, and one or more sidewalls 16 disposed therebetween, defining an interior volume. In the illustrated embodiment, the container 12 comprises a circular cross section, however, in alternate embodiments the container 12 comprises any suitable shaped cross section, such as a rectangle.

In the illustrated embodiment, a lanyard 17 is connected to the container 12 for suspending the container 12 from a user's neck. In alternate embodiments, the lanyard 17 is adjustable in length via a buckle for allowing a user to secure the container 12 to differently sized neck lines. Preferably, the container is worn around a user's neck at all times to remain available in case of an emergency and avoid misplacement. In the illustrated embodiment the lanyard 17 comprises a pair of rings 19 configured to receive the container 12 therethrough and secure to the sidewalls 16. The rings 19 are securely fixed in order to prevent accidental spillage and loss of the container 12 in haste.

A removable seal 22 covers the open upper end 27 of the container 12 and is adapted to protect the contents of the container until the user ready to access the interior volume of the container 12 for the first time. The removable seal 22 is configured to prevent moisture from entering the container 12. In the illustrated embodiments, the removable seal 22 is a hermetic seal. A tab 23 extends from the seal 22 in order to assist a user when removing the seal 22. The tab 23 is preferably the size and shape of a user's fingertip so it can be easily grasped and pulled. In some embodiments, a texture, such as a plurality of ridges, is disposed on an upper and lower surface of the tab 23 in order to assist the grip of the user when pulling on the tab 23. A hinged cap 20 is removably positioned over the seal 22 for allowing access into the interior volume of the container 12, once the seal 22 is removed. In the illustrated embodiment, the cap 20 or hermetic seal 22 includes a perimeter section 28 that is dimensioned to fit around the outside vertical sidewall of the container 12 via a press fit. A top 29 of the cap 20 is movable along a hinge in order to provide a more narrow access to the interior volume of the container 12 than the open end 27 thereof. This allows a user to better control the flow of medication from the container 12. In some embodiments the hinged cap 20 is permanently affixed to the container 16, wherein only the top provides access to the interior volume of the container 16.

A desiccant 24 is secured to the bottom 26 of the container 12 for absorbing moisture. The desiccant 24 is secured to the bottom 26 such that the placement of the desiccant 24 avoids obstructing the flow of medication stored in the container 16. Any suitable desiccant can be used as long as it can be fixed to the closed end of the container 12. In the illustrated embodiment, the desiccant 24 comprises a cylindrical shaped disc in order to fit within the cylindrical shaped container 12. In some embodiments, the container 12 comprises uncoated aspirin 25 so as to assist a user when having a heart attack. In the event of an emergency, it is recommended that the 325 milligram uncoated aspirin is chewed immediately while waiting for emergency responders to arrive after calling 911. The desiccant is secured to the bottom of the container in order to prevent a user from mistakenly removing and accidently chewing the desiccant instead of the 325 milligram uncoated aspirin. Again, the multiple 325 milligram uncoated aspirin in the container is to provide excess in the very possible event of accidental spillage.

The system 11 further comprises a light 13 disposed in a housing having a strobe mechanism 18 operably connected to the light 13 and a control, wherein the control activates the light 13. In the illustrated embodiment, the control is a conspicuous button adapted to be positioned adjacent to a user's interior entryway or exit doorway. The button is brightly colored, such as a lighted blaze orange, in order to remain conspicuous to the user. The housing is adapted to be positioned in a window of the user's residence in order to remain visible to an emergency responder passing thereby. The light 13 is adapted to be activated in an emergency situation, wherein the light 13 flashes via the strobe mechanism 18 so as to alert an emergency responder when he or she approaches the address in which the emergency responder was dispatched. In some embodiments, the light 13 is configured to flash one or more colors, such as bright orange and bright yellow. The light 13 can be installed at an advantageous area, such as the outside of a building or visible through a window in order to remain visible to approaching emergency responders. In one embodiment, the power source for the system 11 is a solar power assembly configured to convert sunlight into electrical energy. Further, the solar power assembly is sufficient to power the light 13.

One or more indicia 14 are adapted to be positioned on an exterior of the user's residence, such as on an adjacent tree or the building itself. In the illustrated embodiment, the indicia 14 is a series of reflective letters and numbers. The indicia 14 comprises a front side having a reflective convex surface and a rear side adapted to be fastened to a surface, wherein the indicia 14 is adapted to alert an emergency responder of the address in which he or she is dispatched. The indicia 14 indicates the alphanumerical address of the user's residence. In this way, the indicia 14, or address of the user, is visible in a dimly lit or dark environment when a vehicle's light shines thereon in order to prevent an emergency responder from passing the address. In one embodiment, the indicia 14 includes a series of numbers zero through ten.

In an emergency situation, such as with the occurrence of a heart attack, it is recommended to immediately take a dose of one 325 milligram chewable uncoated aspirin, call 911, unlock a front door, and wait for the emergency responders to arrive. However, it may be likely that the emergency responders will pass by the residence in which they were dispatched. In operation, the indicia is positioned on the exterior of a residence. After the user has called 911, the seal 22 of the container 12 is removed and the user chews one 325 milligram uncoated aspirin 25. The light 13 having the strobe mechanism is activated and the door is unlocked. The user drastically decreases the chances of an emergency responder from passing by the location in which the emergency responder was dispatched.

Referring now to FIG. 3, there is shown a diagram of the control circuit of the strobe light and the control of the emergency responder alert system. The light 13 is operably connected to the control button 21 and remotely activated thereby. In operation, a user activates the button 21 thereby illuminating the strobe light 13. The light 13 can also be manually operated via an on/off switch disposed thereon. The system 11 is designed to also operate in the event of a power outage.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An emergency responder alert system, comprising:
a container having a bottom and an open end, defining an interior volume;
a seal disposed over the open end;
a desiccant fixed to the bottom of the container, within the interior volume;
a cap covering the open end and seal;
one or more indicia, wherein each indicia comprises a front side having a reflective surface and a rear side adapted to be fastened to a surface;
a strobe light configured to flash.

2) The emergency responder alert system of claim 1, further comprising a plurality of 325 mg uncoated aspirin disposed in the container.

3) The emergency responder alert system of claim 1, further comprising a lanyard secured to the container, wherein the lanyard is configured to suspend the container from a user's neck at all times.

4) The emergency responder alert system of claim 1, further comprising a door lock.

5) The emergency responder alert system of claim 4, a conspicuous button wherein the conspicuous button is operably connected to the light, such that when the conspicuous button is activated the light flashes.

6) A method of alerting an emergency responder with the emergency responder alert system, comprising:
positioning one or more indicia to an exterior of a residence such that a reflective front side of the indicia faces a direction towards a road and a rear side of the indicia is fastened to a surface;
removing a removable seal of a container via a tab positioned on the removable seal;
orally administering one 325 chewable milligram aspirin;
unlocking a door manually;
activating a light having a strobe mechanism by pressing a conspicuous button, wherein the light faces the direction towards the road.

7) The method of alerting an emergency responder with the emergency responder alert system of claim 6, wherein the indicia comprises reflective address numbers having a front surface disposed in a convex shape.

8) The method of alerting an emergency responder with the emergency responder alert system of claim 6, wherein the conspicuous lighted button comprises a blaze orange color and is adapted to be positioned on a wall.
